(19) United States
(12) Patent Application Publication
(10) Pub. No.: US 2019/0191168 A1
(43) Pub. Date: Jun. 20, 2019

(54) VIDEO QUALITY AND THROUGHPUT CONTROL

(71) Applicant: GOOGLE LLC, Mountain View, CA (US)

(72) Inventors: Aki Kuusela, Palo Alto, CA (US); Daniel Stodolsky, Somerville, MA (US); Juha Pekka Maaninen, Sunnyvale, CA (US)

(21) Appl. No.: 15/847,093

(22) Filed: Dec. 19, 2017

(51) Int. Cl. H04N 19/14; H04N 19/567; H04N 19/82

(52) U.S. Cl. CPC H04N 19/14; H04N 19/82; H04N 19/567

(57) ABSTRACT

Systems and methods are disclosed for encoding video. For example, methods may include: receiving a throughput setting; adjusting, based on the throughput setting, an effort level selection for an encoder to utilize multiple effort levels from a set of effort levels, wherein each effort level of the set of effort levels specifies parameters of the encoder that control processing time for a coding unit of video data; and encoding video data, using the encoder configured using effort levels identified by the effort level selection, to generate data of an encoded bitstream.

### BACKGROUND

Digital video streams may represent video using a sequence of frames or still images. Digital video can be used for various applications including, for example, video conferencing, high definition video entertainment, video advertisements, or sharing of user-generated videos. A digital video stream can contain a large amount of data and consume a significant amount of computing or communication resources of a computing device for processing, transmission or storage of the video data. Various approaches have been proposed to reduce the amount of data in video streams, including compression and other encoding techniques.

Encoding based on spatial similarities may be performed by breaking a frame or image into blocks that are predicted based on other blocks within the same frame or image. Differences (i.e., residual errors) between blocks and prediction blocks are compressed and encoded in a bitstream. A decoder uses the differences and reference frames to reconstruct the frames or images.

### SUMMARY

This application relates to encoding video. Disclosed herein are aspects of systems, methods, and apparatuses for encoding video using variable effort levels selected based on a throughput setting.

One aspect of the disclosed implementations is a system for encoding video. The system includes a memory and a processor. The memory stores instructions executable by the processor to cause the system to: receive a throughput setting; adjust, based on the throughput setting, an effort level selection for an encoder to utilize multiple effort levels from a set of effort levels, wherein each effort level of the set of effort levels specifies parameters of the encoder that control processing time for a coding unit of video data; and encode video data, using the encoder configured using effort levels identified by the effort level selection, to generate data of an encoded bitstream.

Another aspect is a method for encoding video. The method includes: receiving a throughput setting; adjusting, based on the throughput setting, an effort level selection for an encoder to utilize multiple effort levels from a set of effort levels, wherein each effort level of the set of effort levels specifies parameters of the encoder that control processing time for a coding unit of video data; and encoding video data, using the encoder configured using effort levels identified by the effort level selection, to generate data of an encoded bitstream.

Another aspect is a system for encoding video. The system includes an integrated circuit configured to implement an encoder and further configured to: receive a throughput setting; adjust, based on the throughput setting, an effort level selection for the encoder to utilize multiple effort levels from a set of effort levels, wherein each effort level of the set of effort levels specifies parameters of the encoder that control processing time for a coding unit of video data; and encode video data, using the encoder configured using effort levels identified by the effort level selection, to generate data of an encoded bitstream.

These and other aspects of the present disclosure are disclosed in the following detailed description of the embodiments, the appended claims and the accompanying figures.

### BRIEF DESCRIPTION OF THE DRAWINGS

The description herein makes reference to the accompanying drawings wherein like reference numerals refer to like parts throughout the several views.

FIG. 1 is a schematic of a video encoding and decoding system.

FIG. 2 is a block diagram of an example of a computing device that can implement a transmitting station or a receiving station.

FIG. 3 is a diagram of a video stream to be encoded and subsequently decoded.

FIG. 4 is a block diagram of an encoder according to implementations of this disclosure.

FIG. 5 is a block diagram of a decoder according to implementations of this disclosure.

FIG. 6 is a block diagram of an example of a system for encoding video.

FIG. 7 is a flowchart of an example of a process for encoding video.

FIG. 8A is a flowchart of an example of a process for encoding video using an effort level map.

FIG. 8B is a flowchart of an example of a process for encoding video using an effort level map with two-pass encoding.

FIG. 9 is a chart of an example set of effort levels.

### DETAILED DESCRIPTION

Architectures and methods for controlling hardware based video encoders are described herein, which may improve video quality and/or compression ratio for an encoded bitstream given a non-worst-case throughput requirement.

Traditional hardware video encoders are built to provide a fixed throughput to meet the highest required data rate, e.g., 2160p (3840×2160) at 60 frames per second. However, especially in video transcoding and real-time video communications, a wide variety of smaller video resolutions and frame rates may be encountered and processed. In these cases the 2160 60 fps capable hardware would have extra clock cycles at its disposal to improve its compression performance. Traditional implementations simply shut off the encoder between these small frames to preserve power, instead of using this extra time to improve compression performance (e.g., video quality and/or compression ratio).

Hardware video encoder architectures are described below that are capable of adjusting the duration it takes to process a frame or a coding unit (e.g., a superblock, a macroblock, or a coding tree unit) through motion estimation, rate-distortion optimized mode selection and quantization. Hyperparameters called effort levels are defined and used to instruct an encoder (e.g., a hardware encoder) how much time it can spend per coding unit. More time spent can improve quality by, for example, expanding motion estimation searches and trying more candidate modes in the rate distortion optimization engine.

Methods and mechanisms are described that control the effort level to improve the encoding time and quality precisely for reaching a targeted throughput. These methods include changing the effort level between frames, and within a frame, so that different coding units are taking different amounts of time to be processed by the encoder. Between frames, a higher effort level may be assigned for key frames and other frames that are deemed more important than others (e.g., anchor frames).

Between coding units, a number of methods may be used to decide which coding units get which effort levels. For example, M of N coding units in a frame may be encoded using a first effort level and the remaining N-M coding units of the frame may be encoded using a second effort level with a different average processing time (where M and N are positive integers). In some implementations, a group of coding units that are assigned an effort level from among multiple effort levels used in a frame may correspond to rectangle selection of coding units within the frame. For example, the frame may be split into an upper rectangle and lower rectangle by a horizontal split with coding units in the upper rectangle using a first effort level and coding units in the lower rectangle using a second effort level. In some implementations, an effort level map that individually specifies the effort levels for respective coding units of a frame may be used. For example, the effort levels of an effort level map may be dynamically determined based on information about the frame of video data (e.g., complexity metrics or bit allocations for coding units within the frame).

Local complexity coding units in a frame may be analyzed for deciding which coding units get more encoding effort and which get less. This analysis can be based on collecting metrics from the pixels, such as variance, edge information, noise, etc. Another way of analyzing complexity is to use two-pass encoding. For example, during a first pass encoding a fixed effort level may be used for all coding units and the bits consumed by each coding unit in the bitstream may be determined (e.g., producing a heat map for the frame). These bit allocations for the coding units (e.g., a heat map) may be used to determine which coding units get higher effort levels and which get lower effort levels in the encoder during a second pass encoding of the frame to generate the final encoded bitstream.

An encoder (e.g., a hardware encoder) may be controlled with a simple fine grained speed knob that specifies a target throughput for encoding a stream of video data (e.g., the throughput may be specified in clock cycles per coding unit, or pixels per second).

This approach may have a number of advantages over other methods. For example, the computing resources of a video encoder may be more efficiently utilized to improve visual quality of compressed video and/or to improve the compression ratio achieved at a given throughput.

Details are described herein after first describing an environment in which the improved image processing for compression disclosed herein may be implemented.

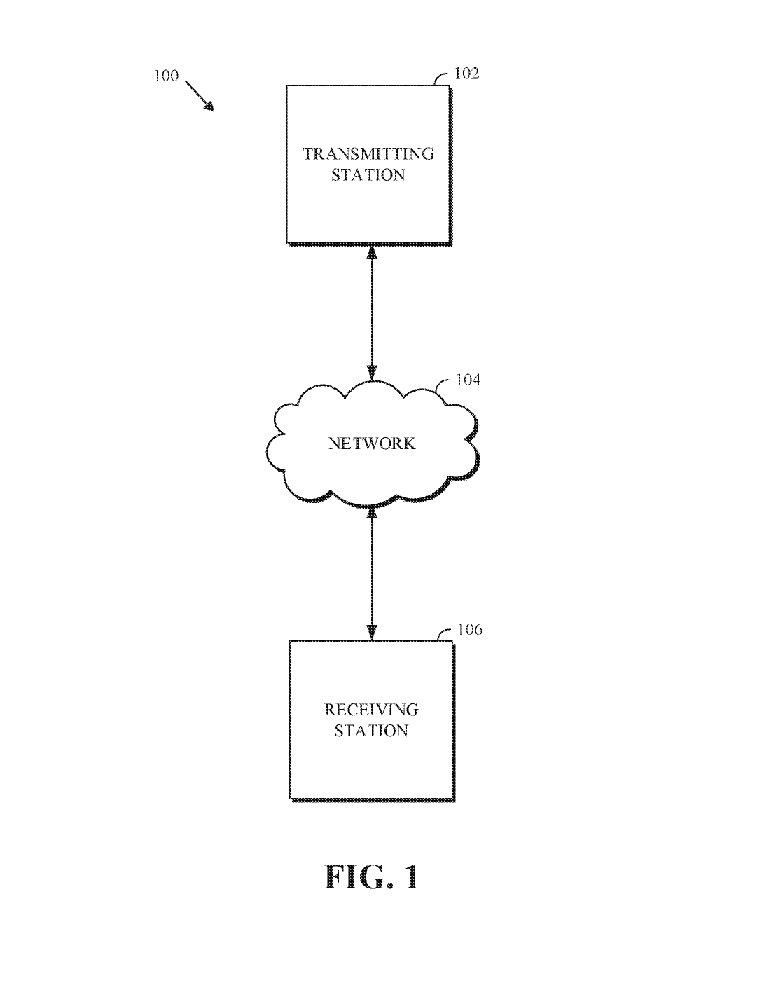

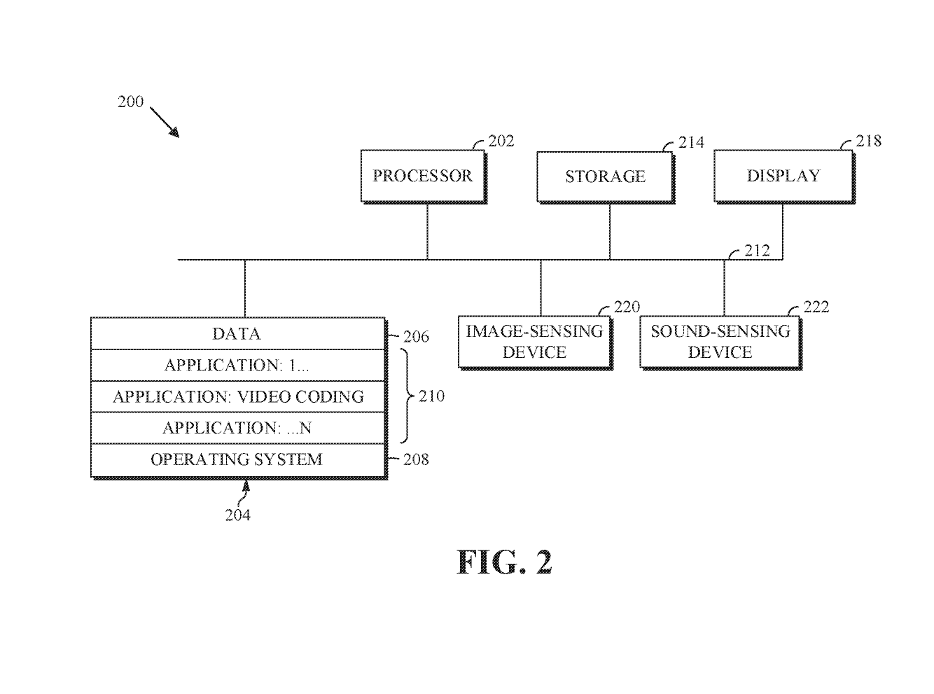

FIG. 1 is a schematic of a video encoding and decoding system 100. A transmitting station 102 can be, for example, a computer having an internal configuration of hardware such as that described in FIG. 2. However, other suitable implementations of the transmitting station 102 are possible. For example, the processing of the transmitting station 102 can be distributed among multiple devices.

A network 104 can connect the transmitting station 102 and a receiving station 106 for encoding and decoding of the video stream. Specifically, the video stream can be encoded in the transmitting station 102 and the encoded video stream can be decoded in the receiving station 106. The network 104 can be, for example, the Internet. The network 104 can also be a local area network (LAN), wide area network (WAN), virtual private network (VPN), cellular telephone network or any other means of transferring the video stream from the transmitting station 102 to, in this example, the receiving station 106.

The receiving station 106, in one example, can be a computer having an internal configuration of hardware such as that described in FIG. 2. However, other suitable implementations of the receiving station 106 are possible. For example, the processing of the receiving station 106 can be distributed among multiple devices.

Other implementations of the video encoding and decoding system 100 are possible. For example, an implementation can omit the network 104. In another implementation, a video stream can be encoded and then stored for transmission at a later time to the receiving station 106 or any other device having memory. In one implementation, the receiving station 106 receives (e.g., via the network 104, a computer bus, and/or some communication pathway) the encoded video stream and stores the video stream for later decoding. In an example implementation, a real-time transport protocol (RTP) is used for transmission of the encoded video over the network 104. In another implementation, a transport protocol other than RTP may be used, e.g., a Hyper-Text Transfer Protocol (HTTP)-based video streaming protocol.

When used in a video conferencing system, for example, the transmitting station 102 and/or the receiving station 106 may include the ability to both encode and decode a video stream as described below. For example, the receiving station 106 could be a video conference participant who receives an encoded video bitstream from a video conference server (e.g., the transmitting station 102) to decode and view and further encodes and transmits its own video bitstream to the video conference server for decoding and viewing by other participants.

FIG. 2 is a block diagram of an example of a computing device 200 that can implement a transmitting station or a receiving station. For example, the computing device 200 can implement one or both of the transmitting station 102 and the receiving station 106 of FIG. 1. The computing device 200 can be in the form of a computing system including multiple computing devices, or in the form of a single computing device, for example, a mobile phone, a tablet computer, a laptop computer, a notebook computer, a desktop computer, and the like.

A CPU 202 in the computing device 200 can be a central processing unit. Alternatively, the CPU 202 can be any other type of device, or multiple devices, capable of manipulating or processing information now-existing or hereafter developed. Although the disclosed implementations can be practiced with a single processor as shown, e.g., the CPU 202, advantages in speed and efficiency can be achieved using more than one processor.

A memory 204 in the computing device 200 can be a read-only memory (ROM) device or a random access memory (RAM) device in an implementation. Any other suitable type of storage device can be used as the memory 204. The memory 204 can include code and data 206 that is accessed by the CPU 202 using a bus 212. The memory 204 can further include an operating system 208 and application programs 210, the application programs 210 including at least one program that permits the CPU 202 to perform the methods described here. For example, the application programs 210 can include applications 1 through N, which further include a video coding application that performs the methods described here. The computing device 200 can also include a secondary storage 214, which can, for example, be a memory card used with a computing device 200 that is mobile. Because the video communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the CPU 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display or light emitting diode (LED) display, such as an organic LED (OLED) display.

The computing device 200 can also include or be in communication with an image-sensing device 220, for example a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the CPU 202 and the memory 204 of the computing device 200 as being integrated into a single unit, other configurations can be utilized. The operations of the CPU 202 can be distributed across multiple machines (each machine having one or more processors) that can be coupled directly or across a local area or other network. The memory 204 can be distributed across multiple machines such as a network-based memory or memory in multiple machines performing the operations of the computing device 200. Although depicted here as a single bus, the bus 212 of the computing device 200 can be composed of multiple buses. Further, the secondary storage 214 can be directly coupled to the other components of the computing device 200 or can be accessed via a network and can comprise a single integrated unit such as a memory card or multiple units such as multiple memory cards. The computing device 200 can thus be implemented in a wide variety of configurations.

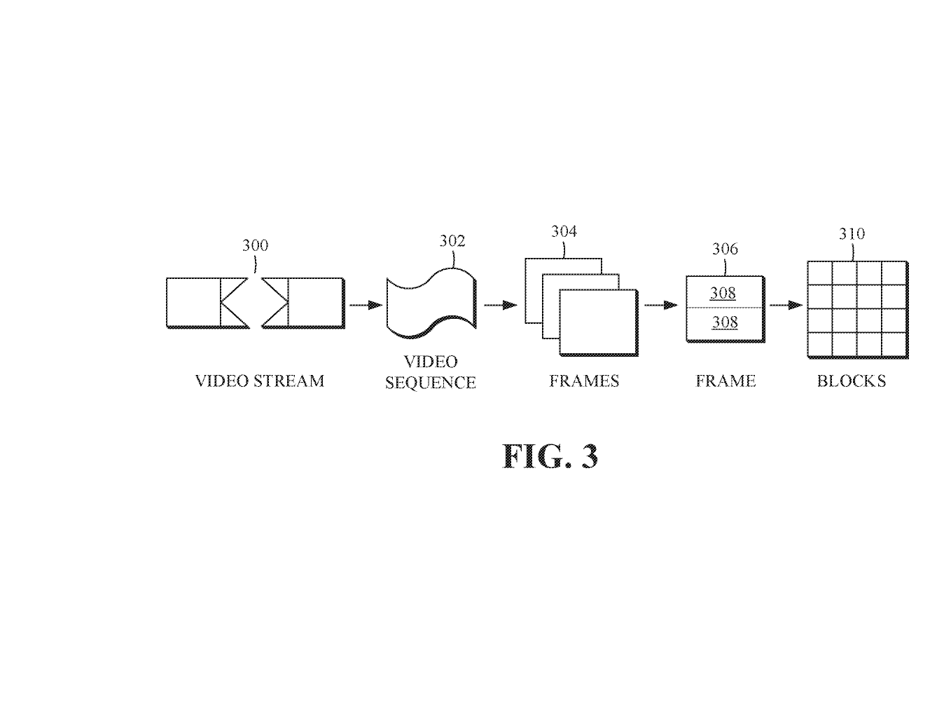

FIG. 3 is a diagram of an example of a video stream 300 to be encoded and subsequently decoded. The video stream 300 includes a video sequence 302. At the next level, the video sequence 302 includes a number of adjacent frames 304. In some cases, a frame may be referred to as a picture. While three frames are depicted as the adjacent frames 304, the video sequence 302 can include any number of adjacent frames 304. The adjacent frames 304 can then be further subdivided into individual frames, e.g., a frame 306. At the next level, the frame 306 can be divided into a series of segments 308 or planes. The segments 308 can be subsets of frames that permit parallel processing, for example. The segments 308 can also be subsets of frames that can separate the video data into separate colors. For example, the frame 306 of color video data can include a luminance plane and two chrominance planes. The segments 308 may be sampled at different resolutions.

Whether or not the frame 306 is divided into the segments 308, the frame 306 may be further subdivided into blocks 310, which can contain data corresponding to, for example, 16×16 pixels in the frame 306. The blocks 310 can also be arranged to include data from one or more segments 308 of pixel data. The blocks 310 can also be of any other suitable size such as 4×4 pixels, 8×8 pixels, 16×8 pixels, 8×16 pixels, 16×16 pixels, 4×32 pixels, 8×32 pixels, 16×32 pixels, 32×4 pixels, 32×8 pixels, 32×16 pixels, 32×32 pixels, 64×64 pixels, or in general N×M pixels, where N, M may be an integer power of 2 like 2, 4, 8, 16, 32, 64, 128, 256, or larger.

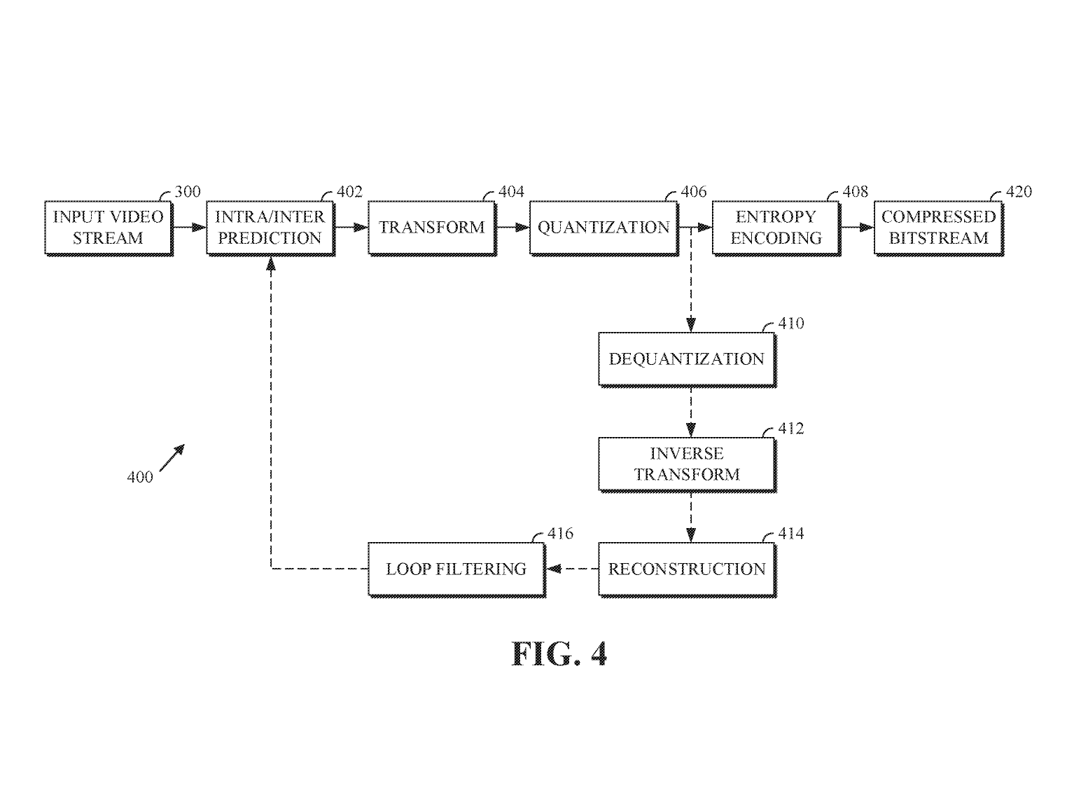

FIG. 4 is a block diagram of an encoder 400 according to implementations of this disclosure. The encoder 400 can be implemented, as described above, in the transmitting station 102 such as by providing a computer software program stored in memory, for example, the memory 204. The computer software program can include machine instructions that, when executed by a processor such as the CPU 202, cause the transmitting station 102 to encode video data in the manner described herein. The encoder 400 can also be implemented as specialized hardware included in, for example, the transmitting station 102. The encoder 400 has the following stages to perform the various functions in a forward path (shown by the solid connection lines) to produce an encoded or compressed bitstream 420 using the video stream 300 as input: an intra/inter prediction stage 402, a transform stage 404, a quantization stage 406, and an entropy encoding stage 408. The encoder 400 may also include a reconstruction path (shown by the dotted connection lines) to reconstruct a frame for encoding of future blocks. In FIG. 4, the encoder 400 has the following stages to perform the various functions in the reconstruction path: a dequantization stage 410, an inverse transform stage 412, a reconstruction stage 414, and a loop filtering stage 416. Other structural variations of the encoder 400 can be used to encode the video stream 300.

When the video stream 300 is presented for encoding, the frame 306 can be processed in units of blocks. At the intra/inter prediction stage 402, a block can be encoded using intra-frame prediction (also called intra-prediction) or inter-frame prediction (also called inter-prediction), or a combination of both. In any case, a prediction block can be formed. In the case of intra-prediction, all or a part of a prediction block may be formed from samples in the current frame that have been previously encoded and reconstructed. In the case of inter-prediction, all or part of a prediction block may be formed from samples in one or more previously constructed reference frames determined using motion vectors.

Next, still referring to FIG. 4, the prediction block can be subtracted from the current block at the intra/inter prediction stage 402 to produce a residual block (also called a residual). The transform stage 404 transforms the residual into transform coefficients in, for example, the frequency domain using block-based transforms. Such block-based transforms include, for example, the Discrete Cosine Transform (DCT) and the Asymmetric Discrete Sine Transform (ADST). Other block-based transforms (e.g., identity transform, transpose, rotation, and Karhunen-Loève transform (KLT)) are possible. Further, combinations of different transforms may be applied to a single residual. In one example of application of a transform, the DCT transforms the residual block into the frequency domain where the transform coefficient values are based on spatial frequency. The lowest frequency (DC) coefficient at the top-left of the matrix and the highest frequency coefficient at the bottom-right of the matrix. It is worth noting that the size of a prediction block, and hence the resulting residual block, may be different from the size of the transform block. For example, the prediction block may be split into smaller blocks to which separate transforms are applied.

The quantization stage 406 converts the transform coefficients into discrete quantum values, which are referred to as quantized transform coefficients, using a quantizer value or a quantization level. For example, the transform coefficients may be divided by the quantizer value and truncated. The quantized transform coefficients are then entropy encoded by the entropy encoding stage 408. Entropy coding may be performed using any number of techniques, including token and binary trees. The entropy-encoded coefficients, together with other information used to decode the block, which may include for example the type of prediction used, transform type, motion vectors and quantizer value, are then output to the compressed bitstream 420. The information to decode the block may be entropy coded into block, frame, slice and/or section headers within the compressed bitstream 420. The compressed bitstream 420 can also be referred to as an encoded video stream or encoded video bitstream, and the terms will be used interchangeably herein.

The reconstruction path in FIG. 4 (shown by the dotted connection lines) can be used to ensure that both the encoder 400 and a decoder 500 (described below) use the same reference frames and blocks to decode the compressed bitstream 420. The reconstruction path performs functions that are similar to functions that take place during the decoding process that are discussed in more detail below, including dequantizing the quantized transform coefficients at the dequantization stage 410 and inverse transforming the dequantized transform coefficients at the inverse transform stage 412 to produce a derivative residual block (also called a derivative residual). At the reconstruction stage 414, the prediction block that was predicted at the intra/inter prediction stage 402 can be added to the derivative residual to create a reconstructed block. The loop filtering stage 416 can be applied to the reconstructed block to reduce distortion such as blocking artifacts.

Other variations of the encoder 400 can be used to encode the compressed bitstream 420. For example, a non-transform based encoder 400 can quantize the residual signal directly without the transform stage 404 for certain blocks or frames. In another implementation, an encoder 400 can have the quantization stage 406 and the dequantization stage 410 combined into a single stage.

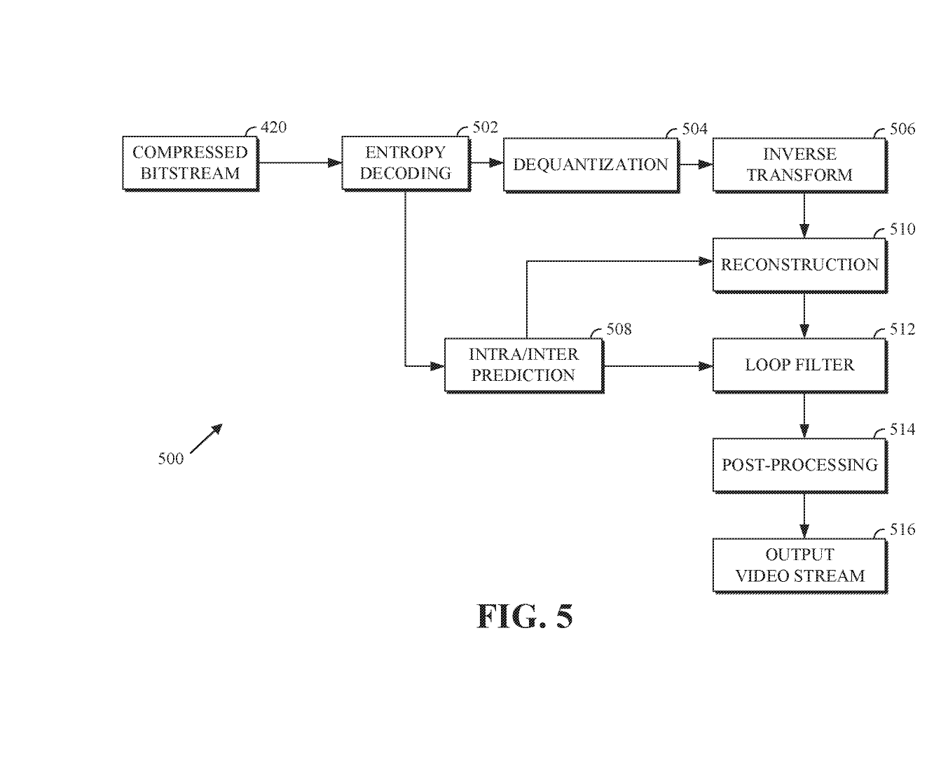

FIG. 5 is a block diagram of a decoder 500 according to implementations of this disclosure. The decoder 500 can be implemented in the receiving station 106, for example, by providing a computer software program stored in the memory 204. The computer software program can include machine instructions that, when executed by a processor such as the CPU 202, cause the receiving station 106 to decode video data in the manner described herein. The decoder 500 can also be implemented in hardware included in, for example, the transmitting station 102 or the receiving station 106. The decoder 500, similar to the reconstruction path of the encoder 400 discussed above, includes in one example the following stages to perform various functions to produce an output video stream 516 from the compressed bitstream 420: an entropy decoding stage 502, a dequantization stage 504, an inverse transform stage 506, an intra/inter-prediction stage 508, a reconstruction stage 510, a loop filtering stage 512 and a post-processing stage 514 (e.g., including deblocking filtering). Other structural variations of the decoder 500 can be used to decode the compressed bitstream 420.

When the compressed bitstream 420 is presented for decoding, the data elements within the compressed bitstream 420 can be decoded by the entropy decoding stage 502 to produce a set of quantized transform coefficients. The dequantization stage 504 dequantizes the quantized transform coefficients (e.g., by multiplying the quantized transform coefficients by the quantizer value), and the inverse transform stage 506 inverse transforms the dequantized transform coefficients using the selected transform type to produce a derivative residual that can be identical to that created by the inverse transform stage 412 in the encoder 400. Using header information decoded from the compressed bitstream 420, the decoder 500 can use the intra/inter-prediction stage 508 to create the same prediction block as was created in the encoder 400, e.g., at the intra/inter prediction stage 402. At the reconstruction stage 510, the prediction block can be added to the derivative residual to create a reconstructed block. The loop filtering stage 512 can be applied to the reconstructed block to reduce blocking artifacts. Other filtering can be applied to the reconstructed block. In this example, the deblocking filtering is applied by the post-processing stage 514 to the reconstructed block to reduce blocking distortion, and the result is output as an output video stream 516. The output video stream 516 can also be referred to as a decoded video stream, and the terms will be used interchangeably herein.

Other variations of the decoder 500 can be used to decode the compressed bitstream 420. For example, the decoder 500 can produce the output video stream 516 without the post-processing stage 514. In some implementations of the decoder 500, the post-processing stage 514 (e.g., including deblocking filtering) is applied before the loop filtering stage 512. Additionally, or alternatively, the encoder 400 includes a deblocking filtering stage in addition to the loop filtering stage 416.

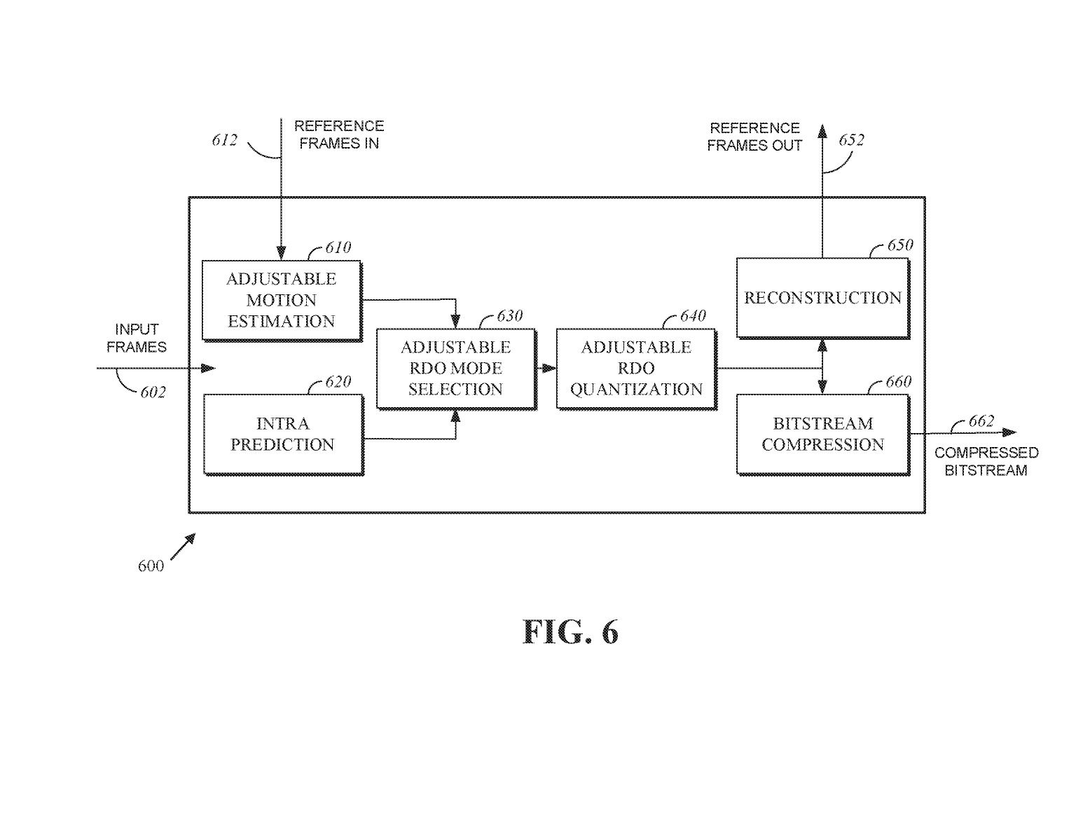

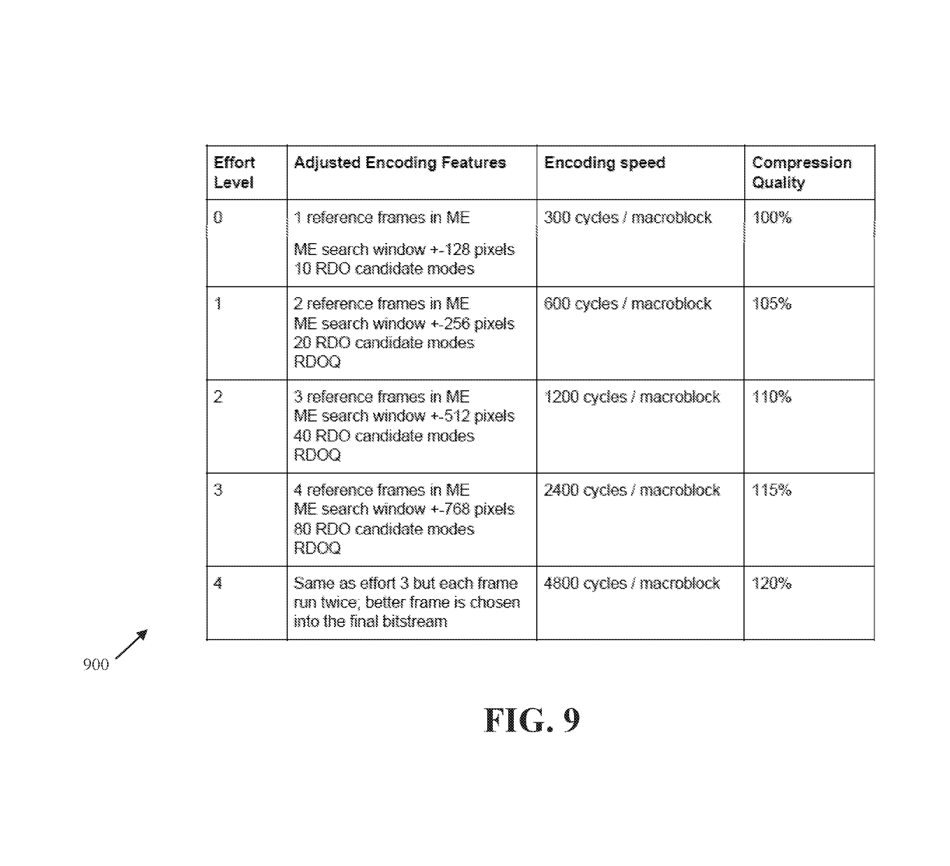

FIG. 6 is a block diagram of an example of a system 600 for encoding video. The system 600 processes input frames 602 of video to generate a compressed bitstream 662. To enable quality and speed adjustments, a hardware implementation of the system 600 may be configured to change how much effort it puts into the encoding process in response to a set of control parameters. The quality of video encoding in general is largely dictated by a few main parts, namely block partitioning, intra prediction, motion estimation, rate distortion optimization and quantization, as well as which coding tools in a supported coding specification are implemented. An encoder hardware architecture of the system 600 may enable the adjustment of these key parts of the encoding process. In this example, the system 600 includes an adjustable motion estimation module 610, an adjustable rate distortion optimization (RDO) mode selection module 630, and an adjustable rate distortion optimization (RDO) quantization module 640. The detailed parameters controlling the speed of the individual blocks may be grouped and selected using a hyperparameter called effort level. For example, the set of effort levels described in relation to FIG. 9 may implemented by the system 600.

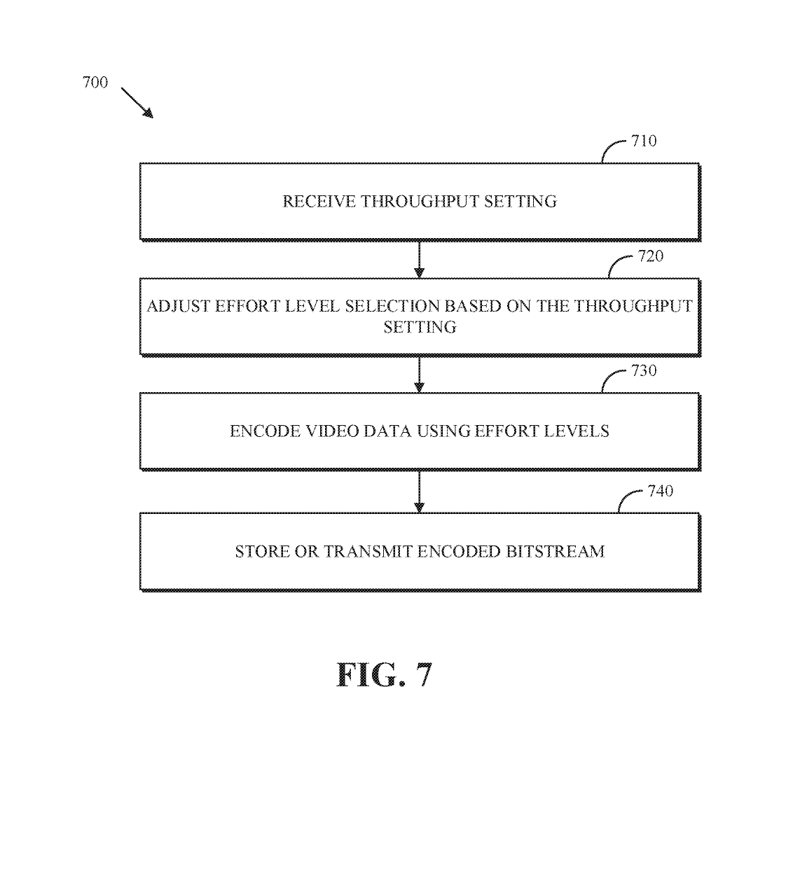

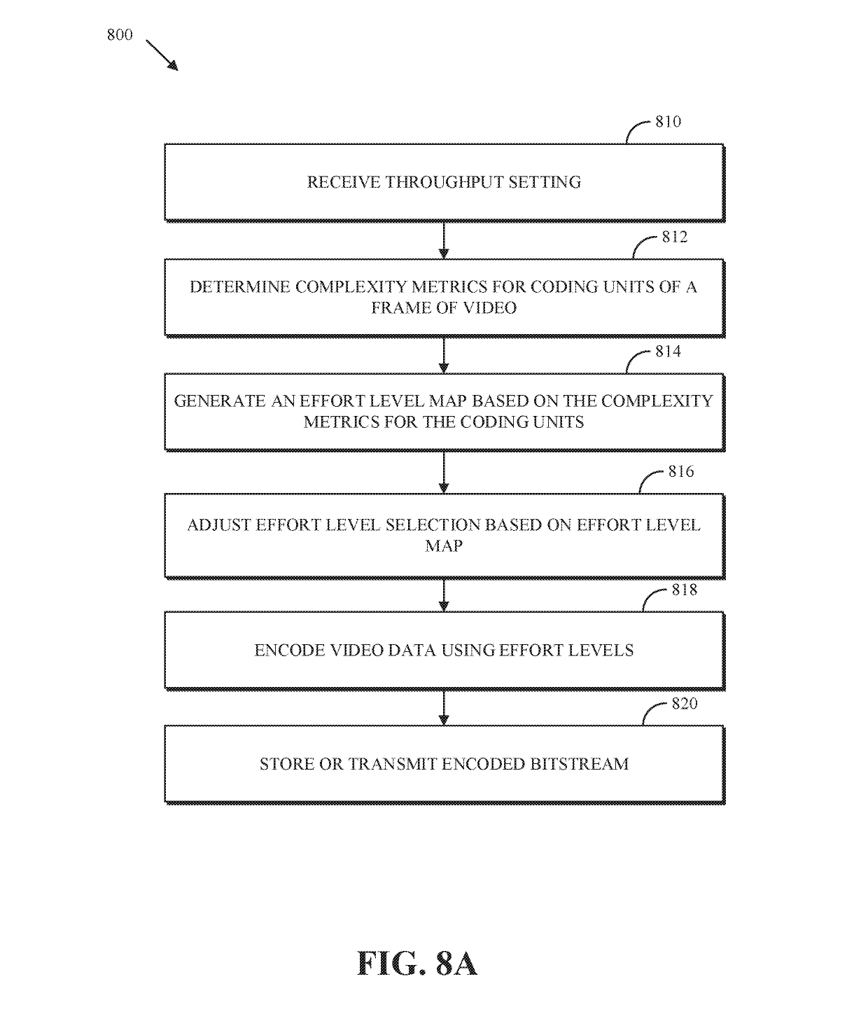

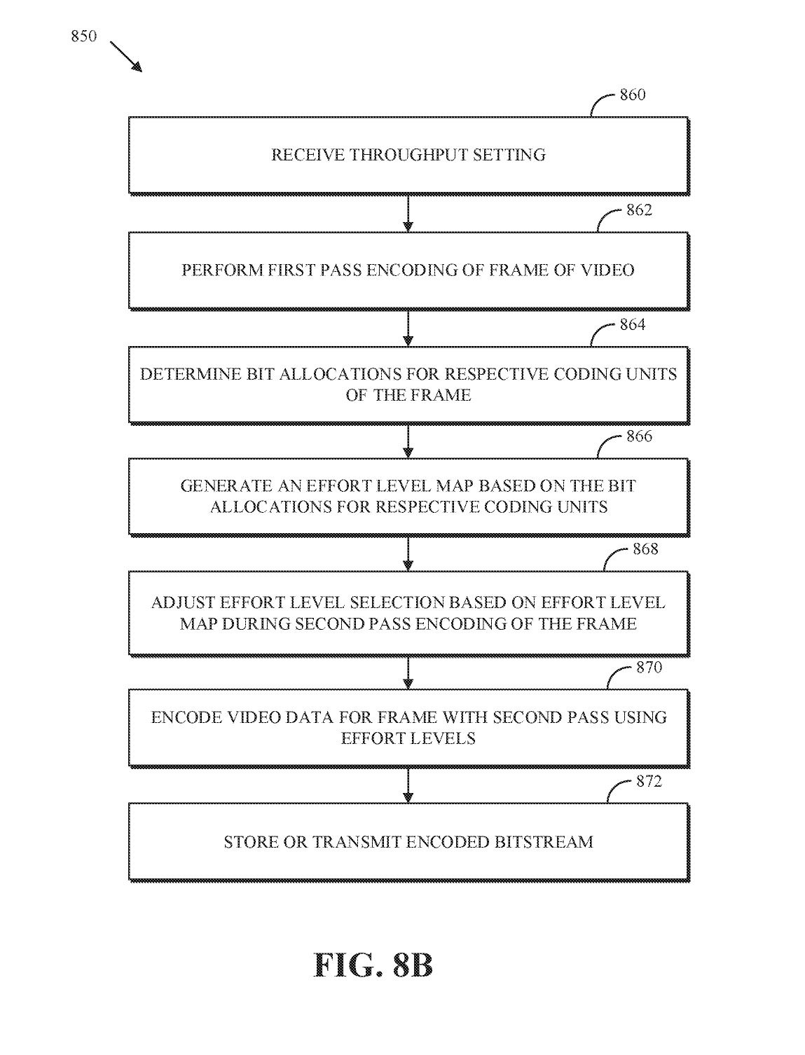

The system 600 can be implemented, as described above, in the transmitting station 102 such as by providing a computer software program stored in memory, for example, the memory 204. The computer software program can include machine instructions that, when executed by a processor such as the CPU 202, cause the transmitting station 102 to encode image data in the manner described herein. The system 600 can also be implemented as specialized hardware included in, for example, the transmitting station 102. For example, the system 600 may implement the process 700 of FIG. 7. For example, the system 600 may implement the process 800 of FIG. 8A. For example, the system 600 may implement the process 850 of FIG. 8B.

The system 600 includes an adjustable motion estimation module 610. The adjustable motion estimation module 610 is configured to find blocks from reference frames 612 that have been previously encoded that match blocks of a current input frame 602. For example, the duration of the motion estimation processing performed by the adjustable motion estimation module 610 can be adjusted by changing the motion estimation search window size and/or precision, as well as the number of reference frames 612 searched for a given input frame 602.

The system 600 includes an intra prediction module 620. The intra prediction module 620 is configured to perform intra-frame prediction to determine a residuals for the input frames 602. For example, the intra prediction module 620 may be configured to perform intra-frame prediction as described in relation to the intra/inter prediction stage 402 of FIG. 4.

The system 600 includes an adjustable rate distortion optimization (RDO) mode selection module 630. The adjustable RDO mode selection module 630 is configured to assess a number of prospective prediction candidate modes (e.g., a combination of certain block partitioning, transform size and type, and best matching intra/inter predictors), and choose a mode that will be encoded into the bitstream. This assessment process may involve estimating both the bit cost of encoding a candidate, as well as the distortion it causes after being quantized. By adjusting the number of candidates the adjustable RDO mode selection module 630 tests, as well as adjusting the precision of this estimation, the computational resources used (e.g., processor clock cycles) and the resulting compression quality can be significantly affected.

The system 600 includes an adjustable rate distortion optimization (RDO) quantization module 640. The adjustable RDO quantization module 640 is configured to perform a lossy part of the encoding process. Time permitting, the adjustable RDO quantization module 640 can be adjusted to either perform a simple quantization, or a more complicated rate-distortion optimized quantization, for example through a trellis or deadzone approach. Rate-distortion optimized quantization requires significantly more effort than a simple quantization, and may be enabled selectively at lower throughput targets for the system 600.

The system 600 includes a reconstruction module 650 configured to generate reference frames 652. The reference frames 652 may match frames that will be generated by a decoder based on the compressed bitstream 662. For example, the reconstruction module may include the dequantization stage 410, the inverse transform stage 412, and the reconstruction stage 414 of FIG. 4. The references frames 652 output by the reconstruction module 650 may be recirculated as reference frames 612 input to the adjustable motion estimation module 610.

The system 600 includes a bitstream compression module 660. The bitstream compression module 660 may be configured to perform lossless entropy encoding of the quantized residuals for the input frames 602 to generate the compressed bitstream 662, which may be stored or transmitted to another device (e.g., the receiving station 106). For example, the bitstream compression module 660 may include the entropy encoding stage 408 of FIG. 4.

In some implementations, in the software level, we can encode each frame multiple times, using different encoding parameters (e.g., choosing different reference frames, different quantization parameters, different deblocking filter levels), to find out which settings yield better video quality and/or better rate control performance.

With an effort level from a set of effort levels defined for use with a video encoder, the encoder (e.g., a hardware encoder) can be instructed tailor its effort level to a desired throughput for an incoming video stream and improve video quality and/or compression ratio for a given encoding task of a particular resolution and frame rate. However the step sizes in encoding time between the effort levels may be large, which may result in residual waste of computing resources when a single effort level is used during a session and the desired throughput does not exactly match with the encoder processing time of the closest effort level. This residual waste of computing resources may be mitigated by fine grained adjust of the effort level to different values during an encoding session to achieve an intermediate average processing time that may correspond more closely to a desired throughput.

For example, effort levels may be switched between consecutive frames. Based on knowledge of the frame encoding duration at different effort levels and the clock frequency of the encoder, a ratio of frames that need to be run at effort level k and k+1 can be calculated, in order to reach the target throughput per second. It may be useful to apply a higher effort level for key frames and anchor frames that may generally require much more bits than the other frames, and may hence benefit more from the higher effort level. This approach may work well for cases that have no real-time constraints. Since the k+1 effort level frames will need more time (e.g., double the time) to process compared to k effort level frames, the rate at which frames are encoded is not constant.

For example, effort levels may be switched between coding units within a frame. This approach may be useful for real-time constrained applications (e.g., video telephony). For example, two effort levels may be applied within each frame to reach the target duration for each frame. Running two different effort levels within a frame may cause visual artifacts. A number of effort level switching strategies mat be applied for spreading out the coding units (e.g., a macroblock, a coding tree unit or a superblock) that are run at different effort levels. In some implementations, for every M of N coding units we apply a k+1 effort level, where k is the base effort level. The first coding unit (e.g., in a raster order) for which k+1 level is applied can be also adjusted, so that the location of k+1 blocks can be varied between subsequent frames. In some implementations, a effort level k is applied to a rectangular region of coding units at a desired location in the frame, and effort level k+1 is applied on the outside of the rectangular region; or inversely k is used outside and k+1 inside the rectangle. In some implementations, an effort level k is applied to coding units in a top part of a frame and an effort level k+1 is applied to coding units in a bottom part of the frame, and the split position is defined by a horizontal line specified by a y offset. In some implementations, an effort level map is used to customize the effort level for each coding unit in a frame individually. This is the most expensive approach for fine grained speed adjustment to implement, but also the most flexible.

FIG. 7 is a flowchart of an example of a process 700 for encoding video. The process 700 includes receiving 710 a throughput setting; adjusting 720, based on the throughput setting, an effort level selection for an encoder to utilize multiple effort levels from a set of effort levels; encoding 730 video data, using the encoder configured using effort levels identified by the effort level selection, to generate data of an encoded bitstream; and storing or transmitting 740 the encoded bitstream. For example, the process 700 may be implemented by an integrated circuit configured to implement an encoder and additional logic for implementing the process 700. For example, the process 700 may be implemented by the system 600 of FIG. 6. For example, the process 700 may be implemented by the computing device 200 of FIG. 2. For example, the process 700 may be implemented by the transmitting station 102 of FIG. 1.

The process 700 includes receiving 710 a throughput setting. The throughput setting may specify a rate at which data of an input video stream will be encoded (e.g., in megapixels/second or as a frame rate and resolution). For example, the throughput setting may be received 710 via user interface (e.g., a graphical user interface (GUI) or a speed knob or dial). The value of throughput setting (e.g., set with a speed knob) may be adjustable between a highest and lowest throughput speed corresponding to respective lowest and the highest effort levels (e.g., 300-4800 cycles/macroblock) supported by an encoder (e.g., the system 600). In some implementations, the throughput setting may be received 710 by an integrated circuit (e.g., via a serial port).

The process 700 includes adjusting 720, based on the throughput setting, an effort level selection for an encoder (e.g., the system 600) to utilize multiple effort levels from a set of effort levels (e.g., the set of effort levels 900). For example, each effort level of the set of effort levels may specify parameters of the encoder that control processing time for a coding unit of video data. For example, an effort level of the set of effort levels may specify at least one parameter from a set of parameters consisting of a number reference frames to process for motion estimation, a search window size for motion estimation, and a number of rate distortion optimization candidate modes. Multiple effort levels may be used within an encoding session to achieve an average throughput corresponding to the throughput setting that is between throughputs that could be achieved using a single effort level for the video encoding session. In some implementations, the effort level selection is adjusted 720 between frames or groups of pictures within an input stream video data. For example, the effort level selection may be adjusted 720 between frames such that at least one frame is encoded with using a first effort level of the set of effort levels and at least one frame is encoded with using a second effort level of the set of effort levels. For example, the effort level selection is adjusted 720 between frames such that anchor frames are encoded with using a first effort level of the set of effort levels and at least one frame is encoded with using a second effort level of the set of effort levels, and the first effort level is associated with a longer processing time than a processing time associated with the second effort level.

The effort level selection may be adjusted 720 between coding units within a frame of the video data. In some implementations, the effort level selection is adjusted 720 between coding units within a frame of the video data such that at least one coding unit of the frame is encoded using a first effort level of the set of effort levels and at least one coding unit of the frame is encoded using a second effort level of the set of effort levels. For example, the effort level selection may be adjusted 720 such that the first effort level is used to the encode a first subset of coding units out of a set of consecutive coding units in a raster order, and the second effort level is used to encode remaining coding units of the set of consecutive coding units. For example, the effort level selection may be adjusted 720 such that the first effort level is used to encode coding units collectively forming a rectangle within the frame and the second effort level is used to the encode coding units located outside of the rectangle. For example, the effort level selection may be adjusted 720 such that the first effort level is used to encode coding units located above a horizontal boundary line and the second effort level is used to the encode coding units located below the horizontal boundary line within the frame. For example, an effort level map may be generated and used to adjust 720 the effort level selection, e.g., as described in relation to the process 800 of FIG. 8A. For example, the effort level setting for coding units within a frame may be adjusted during a second pass encoding based on complexity metrics for those coding units determined during a first pass encoding of the frame, e.g., as described in relation to the process 850 of FIG. 8B.

The effort level selection may be adjusted 720 based on feedback of measurements of actual throughput achieved by an encoder when encoding frames of video data from a current input stream. The actual throughput achieved for particular video may vary due to video complexity and/or target bitrate. For example, an encoder may be implemented as an integrated circuit and include an interface (e.g., a port or a register readable thorough a serial port) for outputting encoding throughput data in real-time from an active video encoding session. For example, the achieved throughput may be monitored via a cycle counter that is software readable through a slave interface and provides a measurement of time used per frame for encoder processing. In some implementations, achieved throughput data may be received from the encoder, and the effort level selection may be adjusted 720 based on the achieved throughput data to better match the throughput setting.

The effort level selection may be adjusted 720 based on feedback of measurements of operating parameters (e.g., current consumption, power consumption, and/or temperature) of an encoder (e.g., an encoder implemented as an integrated circuit) when encoding frames of video data from a current input stream. In some implementations, an encoder may include one or more sensors measuring power consumption (e.g., directly from the power supply or on-chip power management logic), temperature (e.g., from on-chip thermal sensors or thermal diode), and/or current (e.g., directly from the power supply or on-chip power management logic). For example, based on prior calibration or simulation, an activity factor may be calculated for each effort level, wherein each higher effort level results in increased power consumption, heat production, and current usage. Based on recent measurements, the effort level can be adjusted up or down, to decrease an operating parameter (e.g., power, heat, or current) of the encoder or increase compression quality. For example, measurements of current drawn by the encoder may be received, and the effort level selection may be adjusted 720 based on the measurements to reduce current drawn by the encoder. For example, measurements of power consumed by the encoder may be received, and the effort level selection may be adjusted 720 based on the measurements to reduce power consumed by the encoder. For example, measurements of temperature of the encoder may be received, and the effort level selection may be adjusted 720 based on the measurements to reduce temperature of the encoder.

The process 700 includes encoding 730 video data, using the encoder configured using effort levels identified by the effort level selection, to generate data of an encoded bitstream. For example, the encoder may be implemented as an integrated circuit that accepts the effort level selection or parameters of an effort level as control input.

The process 700 includes storing or transmitting 740 the encoded bitstream. For example, the encoded bitstream may be stored 740 in the secondary storage 214 or the memory 204. For example, the encoded bitstream may be transmitted 740 via a network interface from the transmitting station 102, through the network 104, to the receiving station 106.

FIG. 8A is a flowchart of an example of a process 800 for encoding video using an effort level map. The process 800 includes receiving 810 a throughput setting; determining 812 complexity metrics for coding units of the frame; generating 814 an effort level map based on the complexity metrics; adjusting 816 the effort level selection based on the effort level map; encoding 818 video data, using the encoder configured using effort levels identified by the effort level selection, to generate data of an encoded bitstream; and storing or transmitting 820 the encoded bitstream. For example, the process 800 may be implemented by an integrated circuit configured to implement an encoder and additional logic for implementing the process 800. For example, the process 800 may be implemented by the system 600 of FIG. 6. For example, the process 800 may be implemented by the computing device 200 of FIG. 2. For example, the process 800 may be implemented by the transmitting station 102 of FIG. 1.

The process 800 includes receiving 810 a throughput setting. The throughput setting may specify a rate at which data of an input video stream will be encoded (e.g., in megapixels/second or as a frame rate and resolution). For example, the throughput setting may be received 810 via user interface (e.g., a graphical user interface (GUI) or a speed knob or dial). The value of throughput setting (e.g., set with a speed knob) may be adjustable between a highest and lowest throughput speed corresponding to respective lowest and the highest effort levels (e.g., 300-4800 cycles/macroblock) supported by an encoder (e.g., the system 600). In some implementations, the throughput setting may be received 810 by an integrated circuit (e.g., via a serial port).

The process 800 includes determining 812 complexity metrics for coding units of the frame. For example, the complexity metrics for a coding unit (e.g., a macroblock, a coding tree unit, or a superblock) may include variance or results of applying filters such as edge detectors, noise estimators, etc. to the coding unit. The local image content of a frame may be analyzed by determining 812 the complexity metrics for the coding units of the frame to find out which areas in a frame are more likely to benefit from using a larger effort level. For example, very flat or uniform areas of a frame are likely to be coded well already with the fastest effort level, while more complex areas of a frame may benefit from the use of an effort level that uses more processing time (e.g., testing more candidate modes and/or doing more exhaustive motion search).

The process 800 includes generating 814 an effort level map based on the complexity metrics. The effort level map specifies which effort level from the set of effort levels will be used for respective coding units of the frame. For example, the effort level map may include an array of effort level identifiers that are each associated with respective coding units of a frame of video. For example, the values in the effort level map may be selected to have an average processing time for the coding units of the frame that matches the throughput setting, and subject to this constraint, the values in the effort level map may be chosen to allocate more processing time to more complex coding units of the frame and less processing time to less complex coding units.

The process 800 includes adjusting 816 the effort level selection based on the effort level map. For example, the effort level selection may be adjusted 816 for an individual coding unit as specified by a corresponding value in the effort level map for the coding unit.

The process 800 includes encoding 818 video data, using the encoder configured using effort levels identified by the effort level selection, to generate data of an encoded bitstream. For example, the encoder may be implemented as an integrated circuit that accepts the effort level selection or parameters of an effort level as control input.

The process 800 includes storing or transmitting 820 the encoded bitstream. For example, the encoded bitstream may be stored 820 in the secondary storage 214 or the memory 204. For example, the encoded bitstream may be transmitted 820 via a network interface from the transmitting station 102, through the network 104, to the receiving station 106.

FIG. 8B is a flowchart of an example of a process 850 for encoding video using an effort level map with two-pass encoding. The process 850 includes receiving 860 a throughput setting; performing 862 a first pass encoding of a frame; determining 864 bit allocations for respective coding units of the frame during the first pass encoding; generating 866 an effort level map based on the bit allocations for respective coding units; adjusting 868 the effort level selection based on the effort level map during a second pass encoding of the frame; encoding 870 video data for the frame with a second pass, using the encoder configured using effort levels identified by the effort level selection, to generate data of an encoded bitstream; and storing or transmitting 872 the encoded bitstream. For example, the process 850 may be implemented by an integrated circuit configured to implement an encoder and additional logic for implementing the process 850. For example, the process 850 may be implemented by the system 600 of FIG. 6. For example, the process 850 may be implemented by the computing device 200 of FIG. 2. For example, the process 850 may be implemented by the transmitting station 102 of FIG. 1.

The process 850 includes receiving 860 a throughput setting. The throughput setting may specify a rate at which data of an input video stream will be encoded (e.g., in megapixels/second or as a frame rate and resolution). For example, the throughput setting may be received 860 via user interface (e.g., a graphical user interface (GUI) or a speed knob or dial). The value of throughput setting (e.g., set with a speed knob) may be adjustable between a highest and lowest throughput speed corresponding to respective lowest and the highest effort levels (e.g., 300-4800 cycles/macroblock) supported by an encoder (e.g., the system 600). In some implementations, the throughput setting may be received 860 by an integrated circuit (e.g., via a serial port).

The process 850 includes performing 862 a first pass encoding of the frame. For example, the first pass encoding may be performed 862 with the encoder using a constant effort level selection for all coding units of the frame. In some implementations, a default effort level map (e.g., the effort level map for a previous frame of the video) for the coding units of the frame that is not uniform may be used during the first pass encoding.

The process 850 includes determining 864 bit allocations for respective coding units of the frame during the first pass encoding. A bit allocation for a coding unit may be a count of bits used to represent the coding unit in a compressed format (e.g., a compressed bitstream). A set of bit allocations for the respective coding units of a frame is also known as a heat map. In some implementations, the bit allocations determined 864 may further specify how the bits were used within that coding unit (e.g., bits get split between modes, motion vectors and transform coefficients).

The process 850 includes generating 866 an effort level map based on the bit allocations for respective coding units. The effort level map specifies which effort level from the set of effort levels will be used for respective coding units of the frame. For example, the effort level map may include an array of effort level identifiers that are each associated with respective coding units of a frame of video. For example, the values in the effort level map may be selected to have an average processing time for the coding units of the frame that matches the throughput setting, and subject to this constraint, the values in the effort level map may be chosen to allocate more processing time to more complex coding units of the frame and less processing time to less complex coding units.

The process 850 includes adjusting 868 the effort level selection based on the effort level map during a second pass encoding of the frame. For example, the effort level selection may be adjusted 868 for an individual coding unit as specified by a corresponding value in the effort level map for the coding unit.

The process 850 includes encoding 870 video data for the frame with a second pass, using the encoder configured using effort levels identified by the effort level selection, to generate data of an encoded bitstream. For example, the encoder may be implemented as an integrated circuit that accepts the effort level selection or parameters of an effort level as control input.

The process 850 includes storing or transmitting 872 the encoded bitstream. For example, the encoded bitstream may be stored 872 in the secondary storage 214 or the memory 204. For example, the encoded bitstream may be transmitted 872 via a network interface from the transmitting station 102, through the network 104, to the receiving station 106.

FIG. 9 is a chart of an example set of effort levels 900. The detailed parameters controlling the processing speed of the individual blocks within an encoder (e.g., the system 600) are grouped and collectively selected using a hyperparameter called effort level. The chart in FIG. 9 shows an example list of encoding features, encoder speeds, and compression gains for each effort level setting in a set of effort levels 900. In this example, the highest effort level reaches 20% better compression than the lowest level, but requires 16 times more processing cycles. With the set of effort levels 900 defined in FIG. 9, the encoder (a hardware encoder implemented as an integrated circuit) can be instructed to modulate its processing times for portions (e.g., frames or coding units within frames) of an incoming stream of video data to improve video quality for a given encoding throughput setting (e.g., of a particular resolution and frame rate).

The aspects of encoding and decoding described above illustrate some encoding and decoding techniques. However, it is to be understood that encoding and decoding, as those terms are used in the claims, could mean compression, decompression, transformation, or any other processing or change of data.

The words “example” or “implementation” are used herein to mean serving as an example, instance, or illustration. Any aspect or design described herein as “example” or “implementation” is not necessarily to be construed as preferred or advantageous over other aspects or designs. Rather, use of the words “example” or “implementation” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations of transmitting station 102 and/or receiving station 106 (and the algorithms, methods, instructions, etc., stored thereon and/or executed thereby, including by encoder 400 and decoder 500) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of transmitting station 102 and receiving station 106 do not necessarily have to be implemented in the same manner.

Further, in one aspect, for example, transmitting station 102 or receiving station 106 can be implemented using a computer or processor with a computer program that, when executed, carries out any of the respective methods, algorithms and/or instructions described herein. In addition, or alternatively, for example, a special purpose computer/processor can be utilized which can contain other hardware for carrying out any of the methods, algorithms, or instructions described herein.

Transmitting station 102 and receiving station 106 can, for example, be implemented on computers in a video conferencing system. Alternatively, transmitting station 102 can be implemented on a server and receiving station 106 can be implemented on a device separate from the server, such as a hand-held communications device. In this instance, transmitting station 102 can encode content using an encoder 400 into an encoded video signal and transmit the encoded video signal to the communications device. In turn, the communications device can then decode the encoded video signal using a decoder 500. Alternatively, the communications device can decode content stored locally on the communications device, for example, content that was not transmitted by transmitting station 102. Other transmitting station 102 and receiving station 106 implementation schemes are available. For example, receiving station 106 can be a generally stationary personal computer rather than a portable communications device and/or a device including an encoder 400 may also include a decoder 500.

Further, all or a portion of implementations of the present disclosure can take the form of a computer program product accessible from, for example, a tangible computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations and aspects have been described in order to allow easy understanding of the present disclosure and do not limit the present disclosure. On the contrary, the disclosure is intended to cover various modifications and equivalent arrangements included within the scope of the appended claims, which scope is to be accorded the broadest interpretation so as to encompass all such modifications and equivalent structure as is permitted under the law.

1. A system for encoding video, comprising:
a memory; and
a processor, wherein the memory stores instructions executable by the processor to cause the system to:
receive a throughput setting indicating a rate at which video data are to be encoded;
adjust, based on the throughput setting, an effort level selection for an encoder to utilize multiple effort levels from a set of effort levels,
wherein each effort level of the set of effort levels specifies parameters including at least two of a number of reference frames to process for motion estimation, a search window size for motion estimation, or a number of rate distortion optimization candidate modes, and
wherein each effort level corresponds to an instruction to the encoder to use, based on the parameters, a respective maximum time for encoding a coding unit of video data; and
encode video data, using the encoder configured using effort levels identified by the effort level selection, to generate data of an encoded bitstream.

2. The system of claim 1, wherein the encoder is implemented as an integrated circuit that accepts the effort level selection or the parameters of an effort level as control input.

3. The system of claim 1, wherein the effort level selection is adjusted between frames such that at least one frame is encoded with using a first effort level of the set of effort levels and at least one frame is encoded with using a second effort level of the set of effort levels.

4. The system of claim 1, wherein the effort level selection is adjusted between frames such that anchor frames are encoded with using a first effort level of the set of effort levels and at least one frame is encoded with using a second effort level of the set of effort levels, and the first effort level is associated with a longer processing time than a processing time associated with the second effort level.

5. The system of claim 1, wherein the effort level selection is adjusted between coding units within a frame of the video data such that at least one coding unit of the frame is encoded using a first effort level of the set of effort levels and at least one coding unit of the frame is encoded using a second effort level of the set of effort levels.

6. The system of claim 5, wherein the memory stores instructions executable by the processor to cause the system to:
adjust the effort level selection such that the first effort level is used to encode a first subset of coding units out of a set of consecutive coding units in a raster order, and the second effort level is used to encode remaining coding units of the set of consecutive coding units.

7. The system of claim 5, wherein the memory stores instructions executable by the processor to cause the system to:
adjust the effort level selection such that the first effort level is used to encode first coding units collectively forming a rectangle within the frame and the second effort level is used to encode second coding units located outside of the rectangle.

8. The system of claim 5, wherein the memory stores instructions executable by the processor to cause the system to:
adjust the effort level selection such that the first effort level is used to encode first coding units located above a horizontal boundary line and the second effort level is used to second encode coding units located below the horizontal boundary line within the frame.

9. The system of claim 5, wherein the memory stores instructions executable by the processor to cause the system to:
determine complexity metrics for coding units of the frame;
generate an effort level map based on the complexity metrics, wherein the effort level map specifies which effort level from the set of effort levels will be used for respective coding units of the frame; and
adjust the effort level selection based on the effort level map.

10. The system of claim 5, wherein the memory stores instructions executable by the processor to cause the system to:
perform a first pass encoding of the frame;
determine bit allocations for respective coding units of the frame during the first pass encoding;
generate an effort level map based on the bit allocations for respective coding units, wherein the effort level map specifies which effort level from the set of effort levels will be used for respective coding units of the frame; and
adjust the effort level selection based on the effort level map during a second pass encoding of the frame.

11. The system of claim 1, wherein the encoder is implemented as an integrated circuit and the memory stores instructions executable by the processor to cause the system to:
receive achieved throughput data from the encoder; and
adjust the effort level selection based on the achieved throughput data to better match the throughput setting.

12. The system of claim 1, wherein the encoder is implemented as an integrated circuit and the memory stores instructions executable by the processor to cause the system to:
receive measurements of current drawn by the encoder; and
adjust the effort level selection based on the measurements to reduce current drawn by the encoder.

13. The system of claim 1, wherein the encoder is implemented as an integrated circuit and the memory stores instructions executable by the processor to cause the system to:
receive measurements of power consumed by the encoder; and
adjust the effort level selection based on the measurements to reduce power consumed by the encoder.

14. The system of claim 1, wherein the encoder is implemented as an integrated circuit and the memory stores instructions executable by the processor to cause the system to:
receive measurements of temperature of the encoder; and
adjust the effort level selection based on the measurements to reduce temperature of the encoder.

15. The system of claim 1, wherein the memory stores instructions executable by the processor to cause the system to:
store or transmit the encoded bitstream.

16. (canceled)

17. A method for encoding video comprising:
receiving a throughput setting indicating a rate at which video data are to be encoded;
adjusting, based on the throughput setting, an effort level selection for an encoder to utilize multiple effort levels from a set of effort levels,
wherein each effort level of the set of effort levels specifies parameters including at least two of a number reference frames to process for motion estimation, a search window size for motion estimation, or a number of rate distortion optimization candidate modes, and
wherein each effort level corresponds to an instruction to the encoder to use a respective maximum time for encoding a coding unit of video data; and
encoding video data, using the encoder configured using effort levels identified by the effort level selection, to generate data of an encoded bitstream.

18. The method of claim 17, wherein the effort level selection is adjusted between coding units within a frame of the video data such that at least one coding unit of the frame is encoded with using a first effort level of the set of effort levels and at least one coding unit of the frame is encoded with using a second effort level of the set of effort levels.

19. The method of claim 18, comprising:
determining complexity metrics for coding units of the frame;
generating an effort level map based on the complexity metrics, wherein the effort level map specifies which effort level from the set of effort levels will be used for respective coding units of the frame; and
adjusting the effort level selection based on the effort level map.

20. The method of claim 18, comprising:
performing a first pass encoding of the frame;
determining bit allocations for respective coding units of the frame during the first pass encoding;
generating an effort level map based on the bit allocations for respective coding units, wherein the effort level map specifies which effort level from the set of effort levels will be used for respective coding units of the frame; and
adjusting the effort level selection based on the effort level map during a second pass encoding of the frame.

21. An apparatus for encoding video, comprising:
an integrated circuit configured to implement an encoder and further configured to:
receive a throughput setting;
adjust, based on the throughput setting, an effort level selection for the encoder to utilize multiple effort levels from a set of effort levels, wherein each effort level of the set of effort levels specifies parameters of the encoder that control processing time for a coding unit of video data, wherein each effort level corresponds to an instruction to the encoder to use a respective maximum time for encoding the coding unit of video data; and
encode video data, using the encoder configured using effort levels identified by the effort level selection, to generate data of an encoded bitstream.

22. The apparatus of claim 21, wherein the effort level selection is adjusted between coding units within a frame of the video data such that at least one coding unit of the frame is encoded using a first effort level of the set of effort levels and at least one coding unit of the frame is encoded using a second effort level of the set of effort levels.

23. The apparatus of claim 22, wherein the integrated circuit is configured to:
perform a first pass encoding of the frame;
determine bit allocations for respective coding units of the frame during the first pass encoding;
generate an effort level map based on the bit allocations for respective coding units, wherein the effort level map specifies which effort level from the set of effort levels will be used for respective coding units of the frame; and
adjust the effort level selection based on the effort level map during a second pass encoding of the frame.
